(19) United States
(12) Patent Application Publication
(10) Pub. No.: US 2004/0240084 A1
(43) Pub. Date: Dec. 2, 2004

(54) Optical lens

(75) Inventors: Takashi Ito, Saitama City (JP); Takeshi Sakaki, Saitama City (JP)

Correspondence Address: JORDAN AND HAMBURG LLP, 122 EAST 42ND STREET, SUITE 4000, NEW YORK, NY, 10168, US

(73) Assignee: Fuji Photo Optical Co., Ltd., Saitama City (JP)

(21) Appl. No.: 10/838,542

(22) Filed: May 3, 2004

(30) Foreign Application Priority Data
May 27, 2003 (JP) 2003-149205

(51) Int. Cl. G02B 7/02

(52) U.S. Cl. 359/811

(57) ABSTRACT

It is an object of the present invention to provide an optical lens designed to reduce the size and weight of the lens without reducing the lens accuracy of the optical function plane and the optical lens is formed by molding a lens molded component having a flange section around the perimeter of the optical function section and removing at least three sides of the flange section of the lens molded component to reduce the area of the flange, and an engagement section on the outer surface of the flange unremoved section is inscribed in the inner surface of the barrel and thereby engaged with the barrel.

### BACKGROUND OF THE INVENTION

1. Field of the Invention

The present invention relates to an optical lens used for an optical device, etc., and more particularly, to a technology for reducing the size and weight of an optical lens.

2. Description of the Related Art

In an optical lens molded by injecting a plastic material into a metal cavity, a flange section is normally formed around the perimeter of an optical function plane and a convex gate section is formed in the area of the flange section into which the plastic material is injected.

As an optical lens using a conventional technology, there is a proposal on an optical lens with its gate section together with its flange section removed so that the gate section does not become obtrusive when the optical lens is mounted in a barrel and further part of a flange section removed so that the center of gravity of the optical lens is located on the optical axis (Japanese Patent Laid-Open No.411-109106).

With growing demands for a small camera incorporated in a variety of multimedia devices such as a notebook personal computer and cellular phone, a monitoring camera or a small camera for an image input device such as an information terminal such as video cassette recorder or for car-mounted application, there is great expectation for miniaturization and weight reduction of optical lenses in recent years.

### SUMMARY OF THE INVENTION

It is an object of the present invention to provide an optical lens designed to reduce the size and weight of the optical lens without reducing the lens accuracy of the optical function plane and the optical lens is formed by molding a lens molded component having a flange section around the perimeter of the optical function section and removing at least three sides of the flange section of the lens molded component to reduce the area of the flange, and an engagement section on the outer surface of the flange unremoved section is inscribed in the inner surface of the barrel and thereby engaged with the barrel.

### BRIEF DESCRIPTION OF THE DRAWINGS

FIG. 1 illustrates an optical lens according to the present invention;

FIG. 2 illustrates a method of manufacturing the optical lens according to the present invention;

FIG. 3 illustrates an optical lens consisting of only an optical function plane;

FIG. 4 illustrates the optical lens shown in FIG. 1 mounted in a cylindrical barrel; and

FIG. 5 illustrates the optical lens shown in FIG. 1 mounted in a square barrel.

### DETAILED DESCRIPTION OF THE PREFERRED EMBODIMENTS

With reference now to the attached drawings, embodiments of the present invention will be explained below.

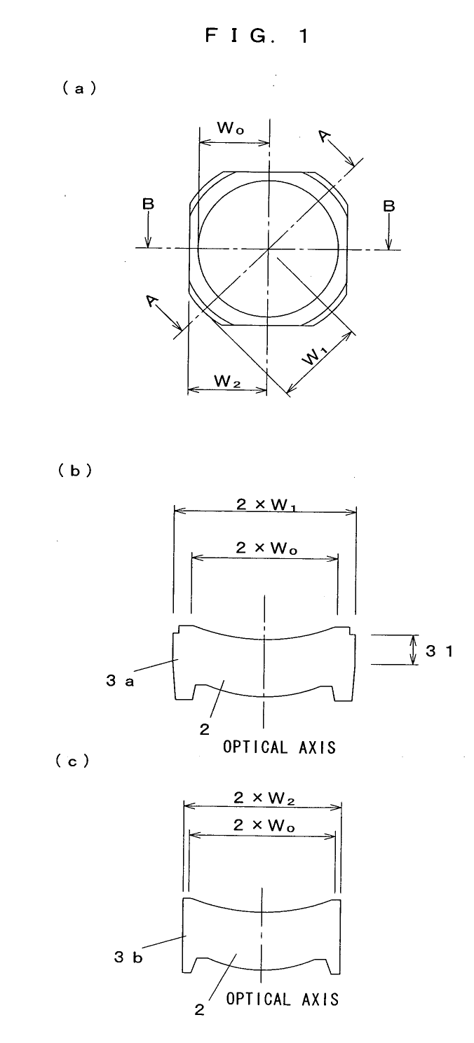

An embodiment of an optical lens 1 according to the present invention is shown in FIG. 1.

FIG. 1 shows an optical lens with four sides of a flange section around the perimeter of an optical function plane 2 removed, FIG. 1(a) is a plan view of the optical lens, FIG. 1(b) is a cross-sectional view along a line A-A shown in FIG. 1(a) and FIG. 1(c) is a cross-sectional view along a line B-B shown in FIG. 1(a).

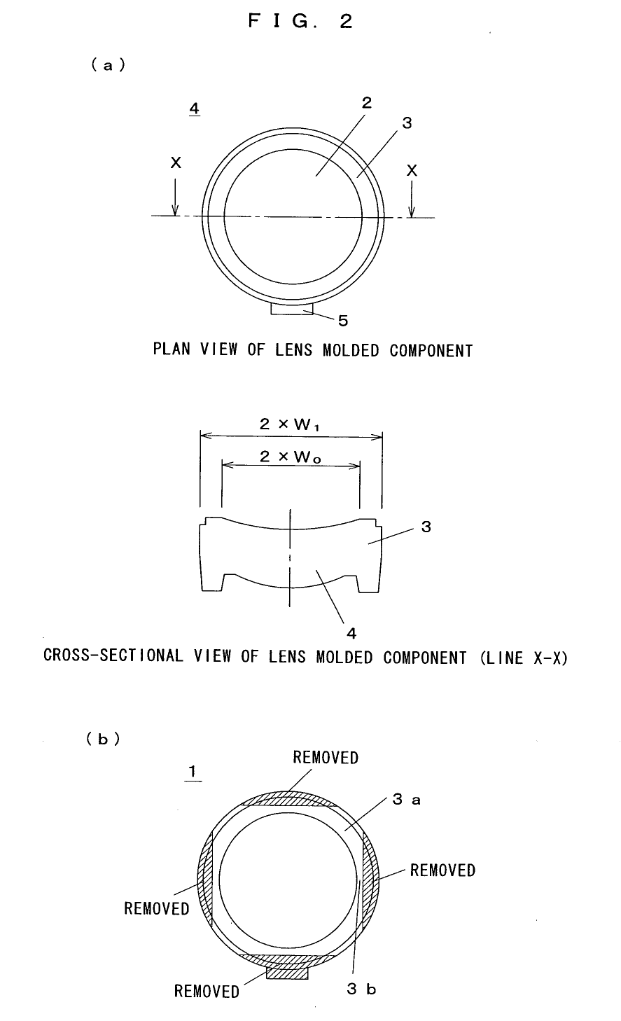

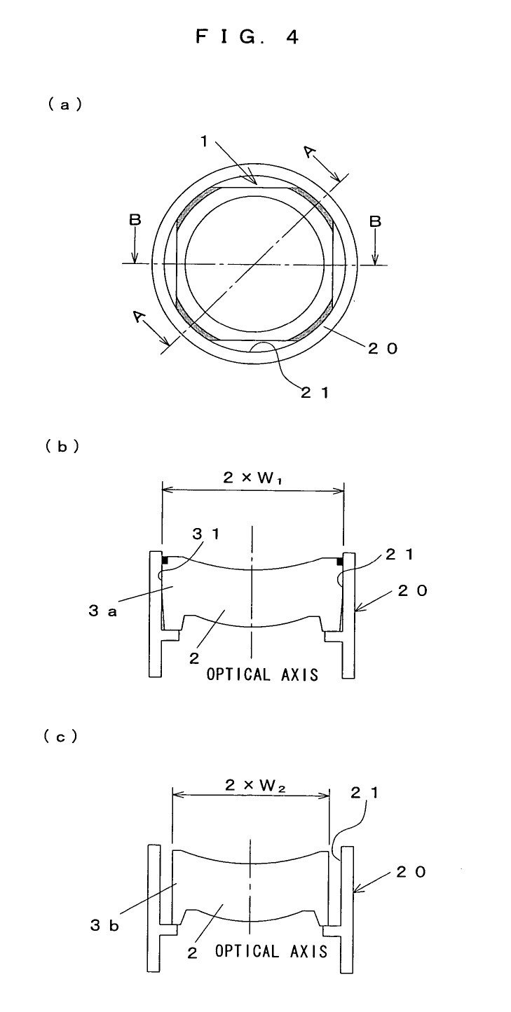

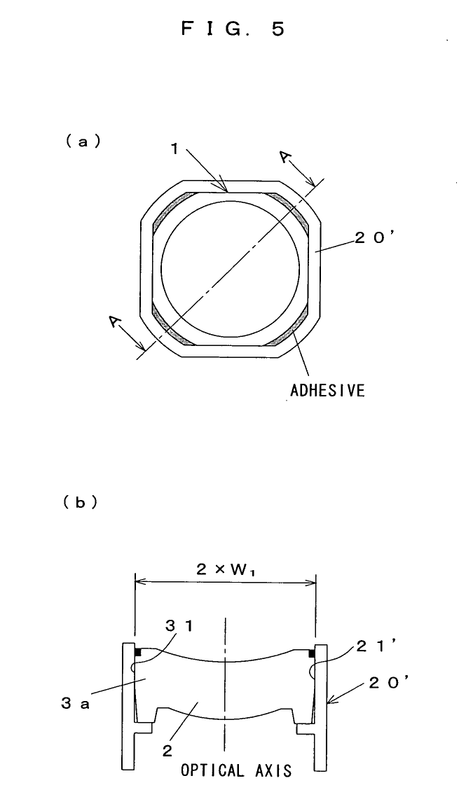

The optical lens 1 shown in FIG. 1 is manufactured in a molding step of molding a lens molded component 4 having a flange section 3 around the perimeter of an optical function plane 2 and in a removing step of removing four sides of the flange section 3 of the lens molded component 4 at regular intervals (see FIG. 2), and when the optical lens 1 is mounted in the barrel 20, an engagement section 31 on the outer surface of a flange unremoved section 3a is inscribed in an inner surface 21 of the barrel 20 and in this way the optical lens 1 is fitted in the barrel 20 (see FIG. 4 and FIG. 5).

In manufacturing an optical lens meeting requirements for a reduction in size and weight, it is also possible to consider molding an optical lens having no flange section 3 around the perimeter of the optical function plane 2.

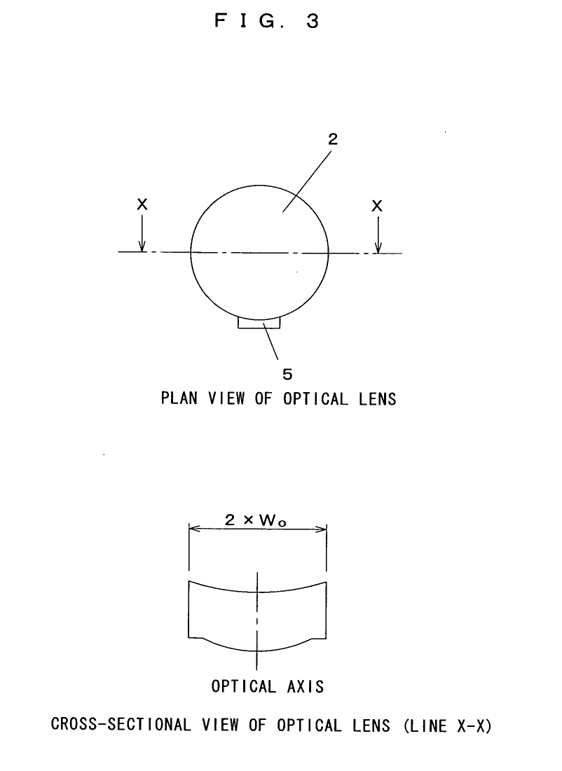

FIG. 3 shows an optical lens 10 made up of only an optical function plane 2. As shown in FIG. 3, in the optical lens 10 made up of only the optical function plane 2, the diameter (2×W₀) of the optical function plane 2 equals the diameter of the lens, which constitutes a small and light optical lens.

However, when the optical lens 10 made up of only the optical function plane 2 is molded, a gate section 5 is formed just beside the optical function plane 2 and inner distortion (birefringence) near the gate section causes the lens accuracy to deteriorate, for example, reducing light transmission of the optical function plane 2.

Moreover, when the optical lens 10 made up of only the optical function plane 2 is mounted in the barrel, the optical function plane 2 directly touches the barrel when assembled and stress applies to the optical function plane 2, which deteriorates the lens accuracy of the optical function plane 2. Furthermore, the optical lens made up of only the optical function plane 2 cannot secure necessary distances from other components (e.g., other lenses arranged in combination with the optical lens) and requires a member (distance ring) to secure the distances from other components, which results in a cost increase.

On the other hand, in manufacturing an optical lens meeting requirements for a reduction in size and weight, it is also possible to consider molding an optical lens with sufficient flange sections and reduced flange sections formed around the perimeter of the optical function plane 2 to thereby reduce the area of the flange.

However, when such an optical lens is metal-molded, in the optical lens with sufficient flange sections (distance from the center of the lens to the outer edge of the lens is W₁) and reduced flange sections (distance from the center of the lens to the outer edge of the lens is W₂) formed around the perimeter of the optical function plane 2 (diameter: W_{O}), the distance from the center of the lens to the outer edge of the lens varies from one place to another, which produces a time variation of solidification of the plastic material, resulting in problems such that the refractive factor inside does not become uniform or it is impossible to form the optical function plane 2 with high accuracy.

Furthermore, in the reduced flange sections, the rim of the optical function plane 2 is quite close to the rim of the lens (the flange is very thin) and it is very difficult to machine a die for molding such an optical lens and, it is difficult to fill the reduced flange sections with a plastic material during injection molding and molding defects such as insufficient filling occur in the above described sections, all of which make stable molding difficult.

The above described problems become more conspicuous in an optical lens of a small lens diameter (e.g., having a lens diameter of approximately φ3 mm to 10 mm) in particular, and it is difficult to obtain an optical lens having a high accuracy optical function plane 2 and meeting requirements for reduction in size and weight at the same time.

In contrast, the optical lens 1 according to the present invention is an optical lens 1 having a high accuracy optical function plane 2 and at the same time meeting requirements for a reduction in size and weight and after molding a lens molded component 4 having a flange section 3 around the perimeter of the optical function plane 2 its flange area is reduced in a removing step of removing the flange section 3.

Note that in the removing step, at least three sides of the flange section 3, preferably three to six sides are removed at regular intervals to form the optical lens 1 with a small flange area.

The step of manufacturing the optical lens 1 shown in FIG. 1 will be explained with reference to FIG. 2.

In manufacturing the optical lens 1 shown in FIG. 1, to secure the high lens accuracy optical function plane 2, a lens molded component 4 having a uniform flange section 3 around the perimeter of the optical function plane 2 is molded as shown in FIG. 2(a).

That is, in the molding step of molding the optical function plane 2 by injecting a plastic material in a metal die cavity, it is possible to secure a sufficient flange around the perimeter of the optical function plane 2 (having a diameter of 2×W_{O}), mold a lens molded component 4 (having a diameter of 2×W₁) having a uniform distance from the center of the lens to the outer edge and thereby mold the high accuracy optical function plane 2.

When the lens molded component 4 is molded using metal molding, the sufficient flange is secured around the perimeter of the optical function plane 2, and therefore there is no adverse effect on the optical function plane 2 during molding.

Furthermore, since the distance from the center of the lens to the outer edge of the lens is uniform, no time difference is produced in solidification of the plastic material and it is possible to mold the high accuracy optical function plane 2 with a uniform refractive factor inside.

After molding the lens molded component 4 having the high accuracy optical function plane 2 (after the molding step), by removing the gate section 5 formed in a convex shape around the perimeter of the flange section 3 of the lens molded component 4 together with the flange section 3 and removing the flange section 3 at intervals of 90°, the area of the flange is reduced (removing step).

In this embodiment, the optical lens 1 with a reduced area of flange is manufactured by removing four sides of the flange section 3 formed around the perimeter of the optical function plane 2 at regular intervals and forming flange unremoved sections 3a whose distance from the center of the lens to the outer edge is W₁ and flange removed sections 3b whose distance from the center of the lens to the outer edge is W₂.

When the area of the flange is reduced by removing the flange section 3 of the lens molded component 4, it is preferable to adjust the removed position and removed area so that the center of gravity of the lens coincides with the position of the optical axis. In this embodiment, the four sides of the flange section 3 are removed at regular intervals in the same way to reduce the area of the flange without producing any shift of the center of gravity of the lens.

In the flange section 3 formed around the perimeter of the optical function plane 2, an engagement section 31 is formed on the outer surface of the flange unremoved section 3a whose distance from the center of the lens to the outer edge is W₁ without removing the flange (see FIG. 1(b)). Then, when this optical lens 1 is mounted in the barrel 20, the engagement section 31 is engaged by being inscribed in the inner surface 21 of the barrel 20.

The optical lens 1 mounted in the barrel 20 will be explained with reference to FIG. 4 and FIG. 5.

FIG. 4 illustrates the optical lens 1 shown in FIG. 1 mounted in the cylindrical barrel 20, FIG. 4(a) is a plan view of the optical lens mounted in the barrel, FIG. 4(b) is a cross-sectional view along a line A-A shown in FIG. 4(a) and FIG. 4(c) is a cross-sectional view along a line B-B shown in FIG. 4(a).

FIG. 5 illustrates the optical lens 1 shown in FIG. 1 mounted in a square barrel 20′, FIG. 5(a) is a plan view of the optical lens mounted in the barrel and FIG. 5(b) is a cross-sectional view along a line A-A shown in FIG. 5(a).

As shown in FIG. 4, when the optical lens 1 in FIG. 1 is mounted in the cylindrical barrel 20, the flange removed section 3b formed around the perimeter of the optical function plane 2 for the purpose of reducing the size and weight of the optical lens 1 provides a space between the outer surface thereof and the inner surface 21 of the barrel 20 where the flange removed section 3b is not supported by (fixed to) the barrel 20 (see FIG. 4(a) and FIG. 4(c)).

However, the engagement section 31 formed on the outer surface of the flange unremoved section 3a around the perimeter of the optical function plane 2 is inscribed in the inner surface 21 of the barrel 20, the optical lens 1 is fitted in the barrel 20 (see FIG. 4(a) and FIG. 4(b)), and therefore there is no problem with the coupling of the barrel 20 and optical lens 1. In this embodiment, an adhesive is applied to the upper part of the outer surface of the flange unremoved section 3a and the optical lens 1 is engaged with the barrel 20 at the engagement section 31 is fixed using the adhesive.

Note that in the flange unremoved section 3a where the flange is sufficiently secured, the optical lens 1 is engaged with the barrel 20, and therefore there is no possibility that stress maybe applied to the optical function plane 2, causing the lens accuracy of the optical function plane 2 to deteriorate.

Furthermore, as shown in FIG. 5, even when the optical lens 1 in FIG. 1 is mounted on the square barrel 20′, the engagement section 31 formed on the outer surface of the flange unremoved section 3a around the perimeter of the optical function plane 2 is inscribed in the inner surface 21 of the barrel 20 and the optical lens 1 is fitted in the barrel 20, and therefore there is no problem with the coupling of the barrel 20 and optical lens 1.

Furthermore, when a conventional optical lens (circular lens having a lens diameter of 2×W₁) with a uniform flange formed around the perimeter of the optical function plane 2 is mounted in a square barrel, a (square) barrel having substantially the same side length as the lens diameter (2×W₁) is used, but when the optical lens 1 with the four sides removed as shown in FIG. 5 is mounted in the square barrel 20′, the engagement section 31 of the flange unremoved section 3a of the optical lens 1 is engaged by being inscribed in the corners (4 corners) of the barrel 20′, and therefore it is only necessary to prepare the (square) barrel 20′ having the length of the diagonal substantially equal to the lens diameter (2×W₁) of the flange unremoved section 3a, making it possible not only to reduce the size and weight of the optical lens but also to miniaturize the barrel.

That is, when an optical lens is mounted in a non-cylindrical barrel, using the optical lens 1 with at least three sides of the flange section 3 of the lens molded component 4 removed according to the shape of the barrel makes it possible not only to reduce the size and weight of the optical lens but also to miniaturize the barrel. Especially when the optical lens is mounted in a square (rectangular) barrel 20′, using the optical lens 1 with the four sides of the flange section 3 of the lens molded component 4 removed makes it possible not only to reduce the size and weight of the optical lens but also to miniaturize the barrel, providing a product having a small outer diameter.

What is claimed is:

1. An optical lens formed by molding a lens molded component having a flange section around the perimeter of an optical function section and then removing at least three sides of the flange section of said lens molded component, wherein an engagement section on the outer surface of the flange unremoved section is inscribed in the inner surface of the barrel and thereby engaged with the barrel.

2. The optical lens according to claim 1, wherein the flange section together with a gate section connected to said flange section is removed.

3. The optical lens according to claim 1, wherein three to six sides of the flange section are removed so as to reduce the area of the flange.

4. The optical lens according to claim 1, wherein four sides of the flange section are removed at regular intervals.
